(19) United States
(12) Patent Application Publication
(10) Pub. No.: US 2014/0362092 A1
(43) Pub. Date: Dec. 11, 2014

(54) LIGHT EMITTING DIODE (LED) BACKLIGHT WITH REDUCED HOTSPOT FORMATION

(71) Applicant: Pixtronix, Inc., San Diego, CA (US)

(72) Inventors: Xiang-Dong Mi, Northborough, MA (US); Jignesh Gandhi, Burlington, MA (US); Jianru Shi, Haverhill, MA (US)

(21) Appl. No.: 13/912,626

(22) Filed: Jun. 7, 2013

(51) Int. Cl. F21V 8/00

(52) U.S. Cl. CPC G02B 6/0068; G02B 6/0085
USPC 345/501; 362/613; 362/608

(57) ABSTRACT

This disclosure provides systems, methods and apparatus for reducing hotspots in backlit displays. Hotspot artifacts in multi-color backlit displays can be reduced by incorporating optical structures along the edges of light guides incorporated into the backlights. The optical structures are positioned adjacent to light emitting modules that emit light into the light guide. Light emitted from the light emitting modules passes through the optical structures before entering the light guide. Hotspot size can be reduced by appropriately configuring the shapes and sizes of these optical structures. In some implementations, the optical structures may include serrations along the side of the light guide adjacent to the light sources. In some other implementations, the optical structures may include dimples. Size of hotspots may also be reduced by reducing the distance between adjacent light sources of the same color.

### TECHNICAL FIELD

This disclosure relates to the field of displays, and in particular, to display backlights.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus having a substantially planar light guide having a first light introduction surface and a second light introduction surface. The apparatus further includes a first light module positioned proximate to the first light introduction surface and a second light module positioned proximate to the second light introduction surface. The first light module includes light sources of a first set of colors, while the second light module includes light sources of a second set of colors, the second set being different from the first set. In some implementations, the first set of colors includes red, green, and blue, and the second set of colors includes white.

In some implementations, the light guide includes a first optical structure disposed on the first light introduction surface proximate to the first light module such that light emitted from the first light module passes through the first optical structure before entering the light guide. The light guide also includes a second optical structure disposed on the second light introduction surface proximate to the second light module such that light emitted from the second light module passes through the second optical structure before entering the light guide. In some implementations, the first optical structure is configured differently from the second optical structure.

In some implementations, at least one of the first optical structure and the second optical structure includes serrations. In some such implementations, the serrations can include protrusions having elliptical cross-sections, the elliptical cross-sections having a first axis and a second axis orthogonal to the first axis, where a ratio of the first axis over the second axis is equal to about 0.83. In some other implementations, at least one of the first optical structure and the second optical structure includes raised dimples.

In some implementations, the apparatus also includes a third light module having light sources of the first set of colors positioned proximate to the first light introduction surface and adjacent to the first light module where a distance between light sources of the same color in the first light module and the second light module is at least four times an emission width of the light sources.

In some implementations, the apparatus further includes a display, a processor that is configured to communicate with the display, the processor being configured to process image data, and a memory device that is configured to communicate with the processor.

In some implementations, the display further includes a driver circuit configured to send at least one signal to the display, and a controller configured to send at least a portion of the image data to the driver circuit. In some implementations, the display further includes an image source module configured to send the image data to the processor, where the image source module includes at least one of a receiver, transceiver, and transmitter, and an input device configured to receive input data and to communicate the input data to the processor.

Another innovative aspect of the subject matter described in this disclosure can be implemented in an apparatus that includes a substantially planar light guide having a light introduction surface having a first axis along the length or the width of the light guide and a second axis along the thickness of the light guide. The apparatus further includes a first set of light modules positioned proximate to the light introduction surface, where the group of light modules are aligned along the first axis, and a second set of light modules positioned proximate to the light introduction surface, each positioned at about a same distance along the first axis and adjacent a corresponding light module in the first set of light modules along the second axis.

In some implementations, the first set of light modules includes a first light module having a red light source, a green light source and a blue light source and a second light module having a white light source. In some implementations, the red light source, the green light source, and the blue light source of the first light module are aligned along the longer dimension of the light introduction surface.

In some implementations, the apparatus further includes a third set of light modules positioned adjacent to the first set of light modules along the first axis, where a distance between a light source of a color in the first set of light modules and a light source of the same color in the third set of light modules is at least four times an emission width of the light source of the color.

In some implementations, the apparatus further includes a first optical structure disposed on the light introduction surface proximate to the first set of light modules such that light emitted from the first set of light modules passes through the first optical structure before entering the light guide. In some such implementations, the first optical structure includes serrations extending along the shorter dimension of the light introduction surface. In some other such implementations, the first optical structure includes dimples.

Another innovative aspect of the subject matter described in this disclosure can be implemented in an apparatus including means for displaying images. The apparatus further includes means for guiding light to illuminate the means for displaying images. The apparatus also includes means for generating the light to input to the means for guiding light, the means for generating the light including first means for generating light of a first set of colors and second means for generating light of a second set of colors, where the first set of colors and the second set of colors are different. The apparatus also includes means for reducing hotspots formed by the light in the means for guiding light.

In some implementations, the means for reducing hotspots includes a first set of serrations to refract the light of the first set of colors and a second set of serrations to refract the light of the second set of colors, where the first set of serrations and the second set of serrations are of different dimensions. In some implementations, the first set of colors includes red, green, and blue, and the second set of colors includes white.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIGS. 3A-3C show various views of an example multi-color illuminated backlight.

FIG. 4 shows examples of optical elements for reducing hotspots in the backlight.

FIGS. 5A-5C show various examples of optical elements having various stretching factor values.

FIGS. 6A-6C show simulation results obtained for a light guide.

FIGS. 7A-7B show various views of another example multi-color illuminated backlight.

FIGS. 8A-8C show various views of yet another example multi-color illuminated backlight.

FIG. 9 shows a top view of another example multi-color illuminated backlight.

FIGS. 10A and 10B are system block diagrams illustrating an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Hotspot artifacts in multi-color backlit displays can be reduced by incorporating optical structures along the edges of light guides incorporated into the display backlights. The optical structures are positioned adjacent to light emitting modules that emit light into the light guide. Thus, light emitted from the light emitting modules passes through the optical structures before entering the light guide. Hotspot size can be reduced by appropriately configuring the shapes and sizes of the optical structures.

The size of hotspots may also be reduced by reducing the distance between adjacent light sources of the same color. In some implementations, light modules having different colored light sources can be stacked one on top of the other. In some other implementations, light modules having one set of colored light sources may be placed on a first side of a light guide while light modules having a second set of colored light sources can be positioned on a side of the light guide that is opposite to the first side.

Particular implementations of the subject matter described in this disclosure can be implemented to realize one or more of the following potential advantages. Incorporating optical structures that modify the light entering a light guide of a backlight display can reduce the size of hotspots formed within the light guide. Reducing the size of hotspots can reduce hotspot based artifacts that may appear in images displayed to a viewer.

In some implementations, the size of the hotspots can be further reduced by placing light sources near the edge of the light in close proximity.

In some implementations, packaging light sources of various colors within a common light module allows for a reduced pitch between light sources of the same color, thereby further reducing the size of hotspots. In some other implementations, stacking light modules having different color light sources along the light guide surface can similarly allow for a reduced pitch, thereby further reducing the size of hotspots.

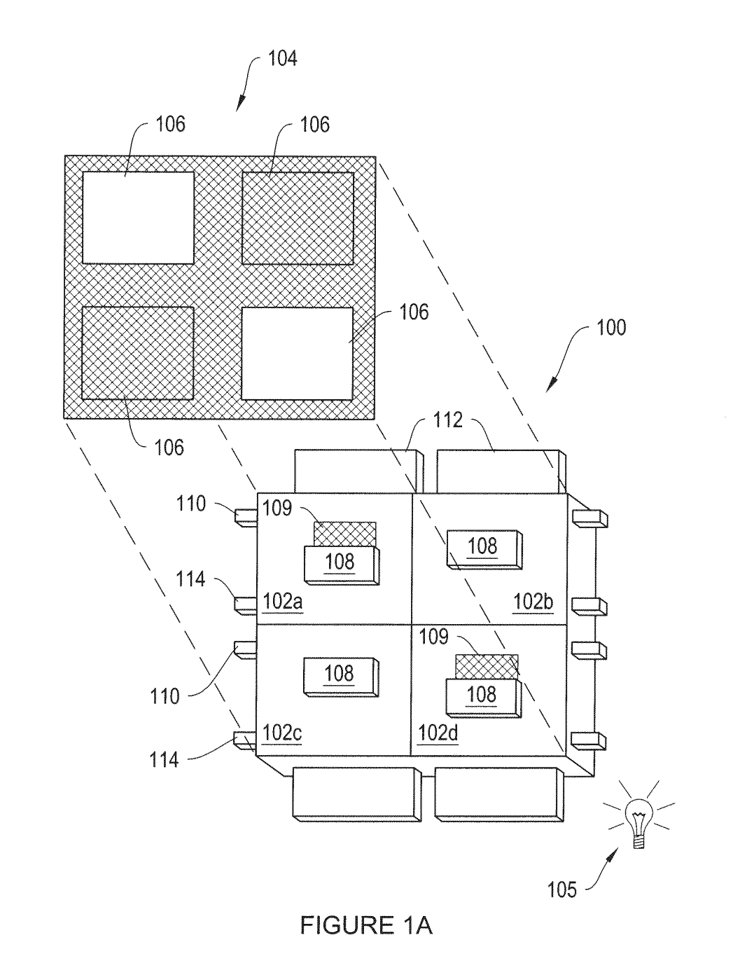

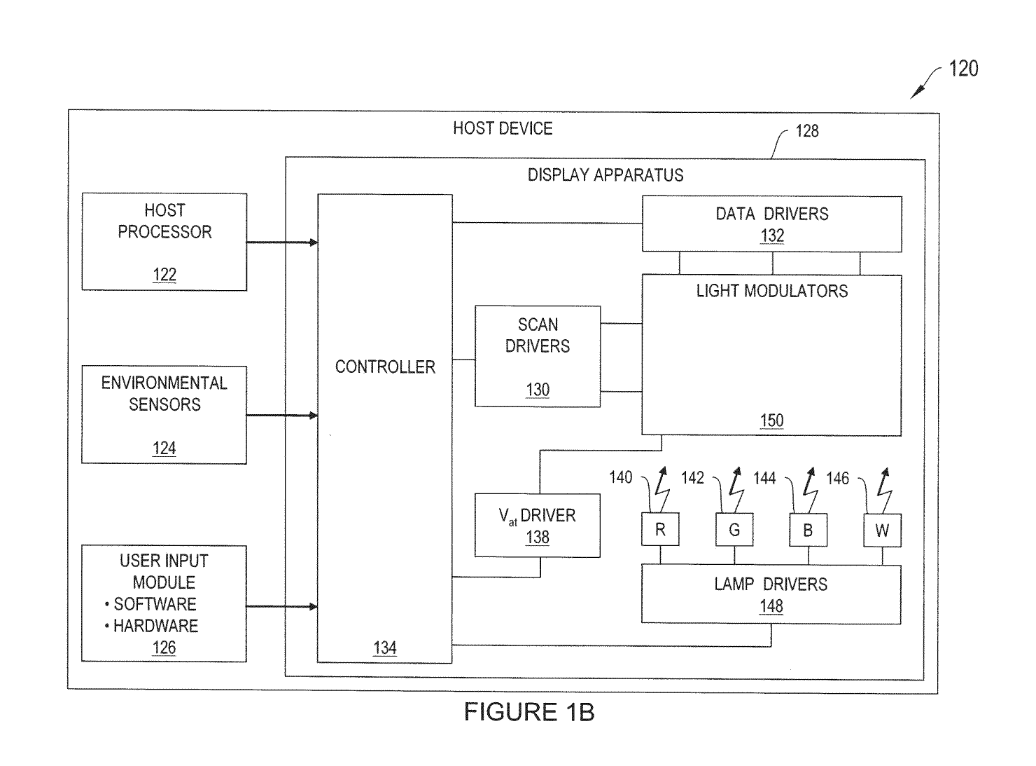

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

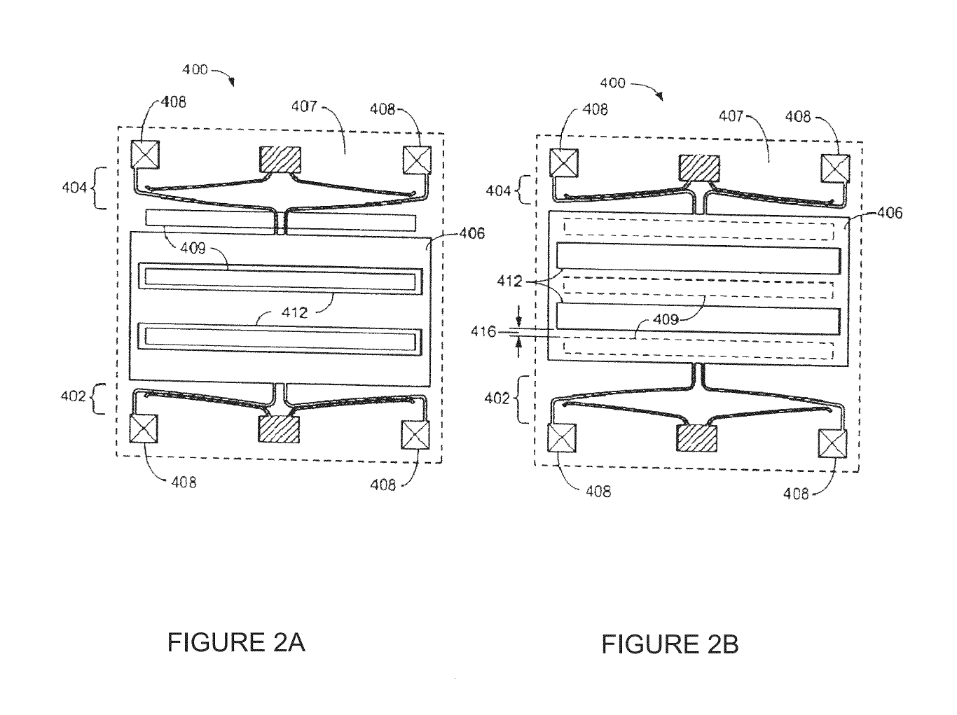

FIGS. 2A and 2B show views of an example dual actuator shutter assembly 400. The dual actuator shutter assembly 400, as depicted in FIG. 2A, is in an open state. FIG. 2B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. A control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 2A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 2B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 2B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

Displays employing backlights that incorporate point light sources such as light emitting diodes (LEDs) can suffer from visual artifacts referred to as hotspots at the edges of the display. A hotspot is an area on a display in which the brightness of a given color is noticeably greater in comparison to adjacent areas of the display. In LED edge-lit displays, hotspots frequently occur adjacent to the locations along the edges of the display at which light from an LED or an LED module is introduced into the backlight.

Some edge-lit displays have incorporated microstructures, such as serrations or V or M-shaped cut-outs into the edges of their light guides adjacent each LED. These structures help diffuse the light emitted by the LED more evenly into the backlight.

Hotspots are particularly troublesome for displays employing multi-color LEDs, such as red (R), green (G), and blue (B) or red (R), green (G), blue (B) and white (W), because the spacing between adjacent LEDs of the same color is increased, making it more difficult to mitigate the hotspots merely by increasing the density of LEDs along the perimeter of the display.

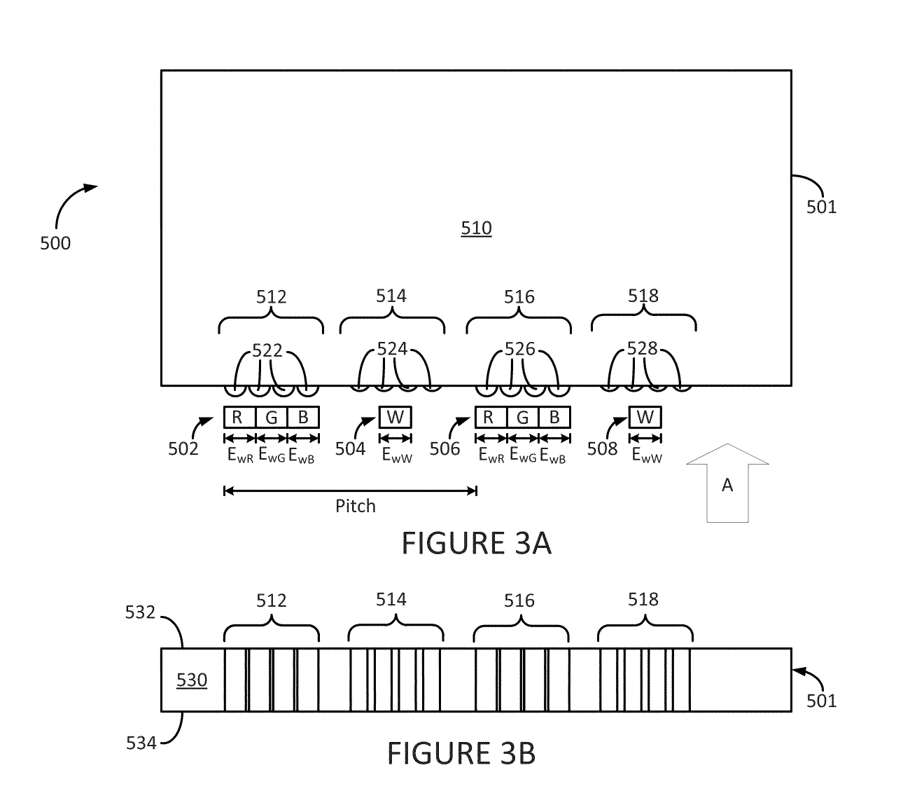

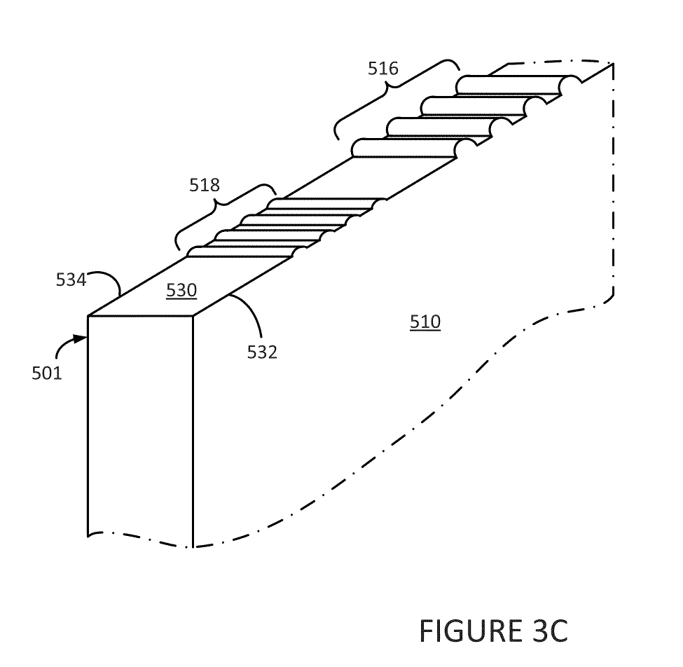

FIGS. 3A-3C show various views of an example multi-colored illuminated backlight 500. In particular, FIG. 3A shows a front view of the backlight 500, FIG. 3B shows a side view of a light guide 501 of the backlight 500, and FIG. 3C shows an isometric view of the light guide 501. The backlight 500 may be incorporated into the direct-view MEMS-based display apparatus 100 (shown in FIG. 1A), where the backlight 500 can replace, or operate in combination with, the lamp 105.

The backlight 500 includes one or more light modules for providing light of various colors. Specifically, the backlight 500 can include a first light module 502, a second light module 504, a third light module 506, and a fourth light module 508. The first and third light modules 502 and 506 include three light sources, one each for emitting substantially red (R), green (G), and blue (B) light. It is understood that in some implementations more than one light source may be included in a given light module for generating light of the same color. The second light module 504 emits substantially white (W) light. In some implementations, such as the one shown in FIGS. 3A-3C, the light sources of the red, green, and blue colors are packaged in a single physical module, while the light source of white color is packaged in a separate physical module. Specifically, a first set of light sources of red, green, and blue colors are packaged in the first light module 502 and a second set of light sources of red, green, and blue colors are packaged in the third light module 506. The light sources of the white color, however, are packaged in the second light module 504 and the fourth light module 508. In some other implementations, the light sources of all colors (red, green, blue, and white) may be packaged in one common light module.

The number of light modules in a given backlight can be different from that shown in FIG. 3A. For example, in some implementations, the backlight 500 may include only the first light module 502 (including red, green, and blue light sources) and the second light module 504 (including the white light source). In some other implementations, the backlight 500 may include more than four light modules. For example, the backlight 500 may include more than two light modules having red, green, and blue light sources. Generally, the number of light modules included in the backlight 500 may be a function of the maximum illumination intensity of each light source within the module, the total specified illumination intensity for the backlight 500, the dimensions of the light guide 501, the resolution of the digital-to-analog controller (DAC) used to control the light sources within the light module, etc. If the maximum illumination intensity of a light source of a color in a light module is insufficient to meet the total specified illumination intensity of that color for the backlight 500, then the backlight 500 may include more than one light module such that the sum of maximum light intensities of light sources of all the light modules can be at least equal to the total specified illumination intensity for the backlight 500.

The light modules 502, 504, 506, and 508 can be arranged along a side of the light guide 501, as shown in FIG. 3A, such that the light emitted by the light sources within these modules can be introduced into the light guide 501. The light modules can be arranged in an alternating fashion, such that any two adjacent light modules are different. For example, the second light module 504 including the white light source can be interspaced between the first light module 502 and the third light module 506, both of which include the red, green, and blue light sources. Each of the light sources within each module can have a dimension that is substantially parallel to the side of the light guide 501 along which the light modules are situated. For example, the red light sources in each of the first light module 502 and the third light module 506 have a width, referred to hereinafter as the “emission width” (or E_{wR}). Similarly, the green, blue, and white light sources have emission widths denoted by E_{wG}, E_{wB}, and E_{wW}, respectively.

In some implementations, the light modules may be closely packed such that the distance (referred to as “Pitch” in FIG. 3A) between adjacent light sources of the same color is kept as small as possible. In some implementations, especially when utilizing light modules having multiple color sources, or using multiple light modules of different colors, the pitch can be multiple times the emission width of the light source. In particular, with the configuration of the light sources shown in FIG. 3A, in which red, green, blue and white light sources in light modules 502, 504, 506, and 508 are arranged adjacent to each other in that order along an edge of the light guide 501, the pitch can be greater than or equal to four times the emission width of the light source of that color. For example, adjacent placement of the first light module 502, the second light module 504 and the third light module 506 may result in the distance P between the red light sources in the first light module 502 and the third light module 506 being greater than or equal to than four times the emission width E_{wR} of the red light sources. In contrast, in some implementations utilizing a single colored backlight (for example, a white backlight coupled with color filters), the light modules would include light sources of the same color. Arranging such light modules adjacent to each other can result in a substantially smaller pitch compared to back lights with multiple colored light sources, such as the backlight shown in FIG. 3A. Generally, a decrease in the ratio of the emission width, E_{w}, for light sources of a color over their pitch results in an increase in the size of the hotspots generated for that color. Thus, the high pitch associated with backlights having light sources of multiple colors, such as the one shown in FIG. 3A, can pose a challenge with regards to mitigating or preventing hotspots.

In some implementations, the light sources of all the different colors may be combined into a single light module. For example, the first light module 502 may include a white light source in addition to the red, green, and blue light sources. In such implementations, the backlight 500 may not include the second light module 504 and the fourth light module 508, each of which include only white light sources. In some such implementations, the light modules may still be arranged such that the distance between adjacent light sources of the same color is more than about four times the emission width of the light source of that color. In some light modules, a significant portion of the width of the light module may be allocated to packaging a light source. This can deteriorate the pitch between light sources in adjacent light modules. By combining multiple light sources within a single light module, the portion of the width of the light module allocated to packaging can be reduced, thereby reducing the pitch between light sources in adjacent light modules.

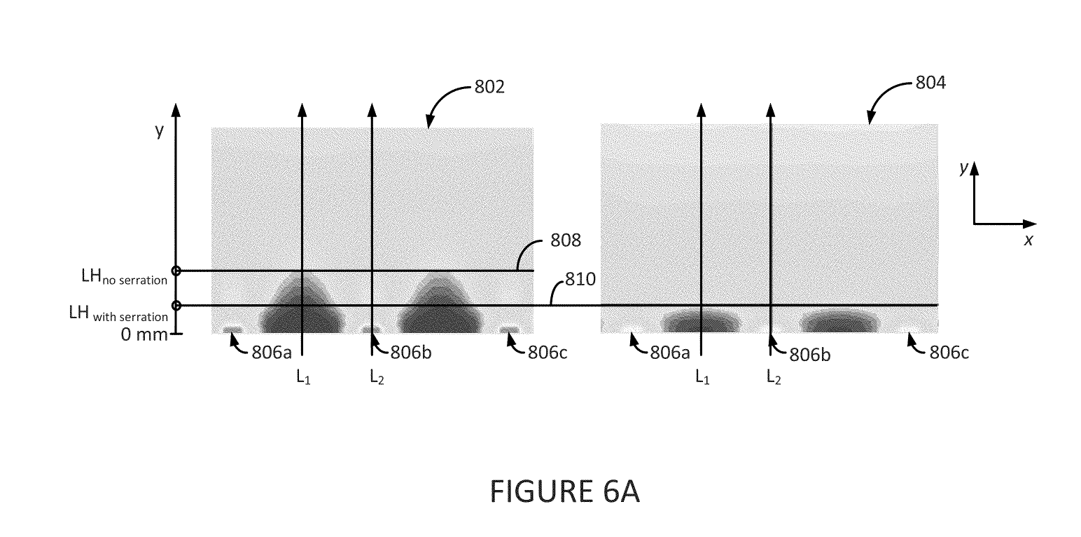

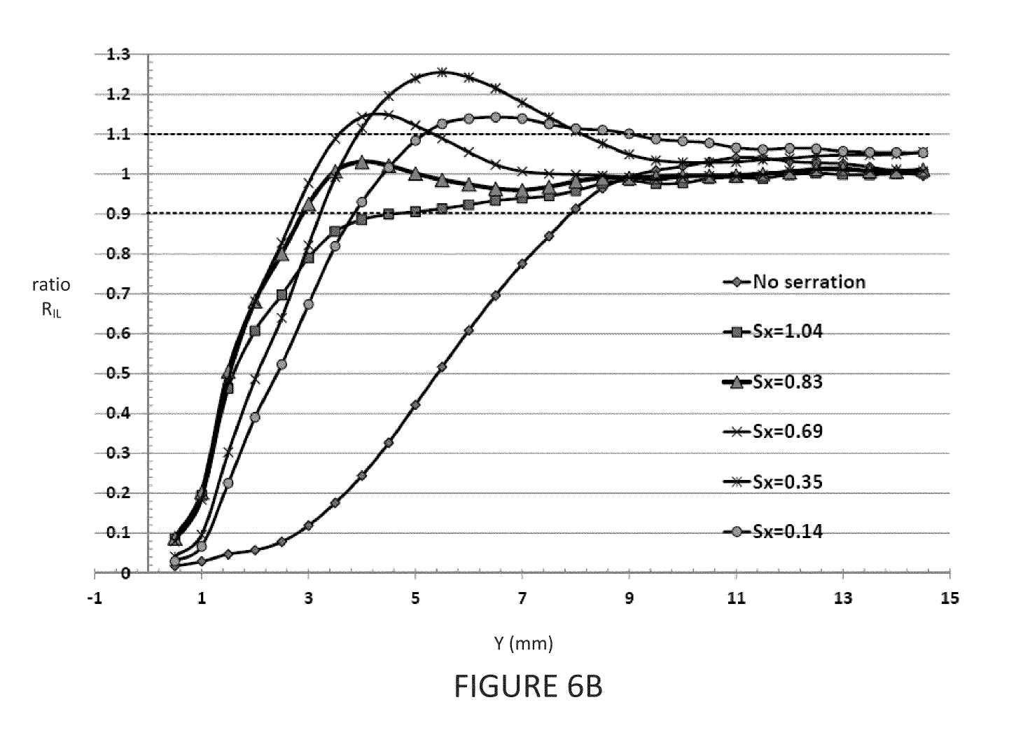

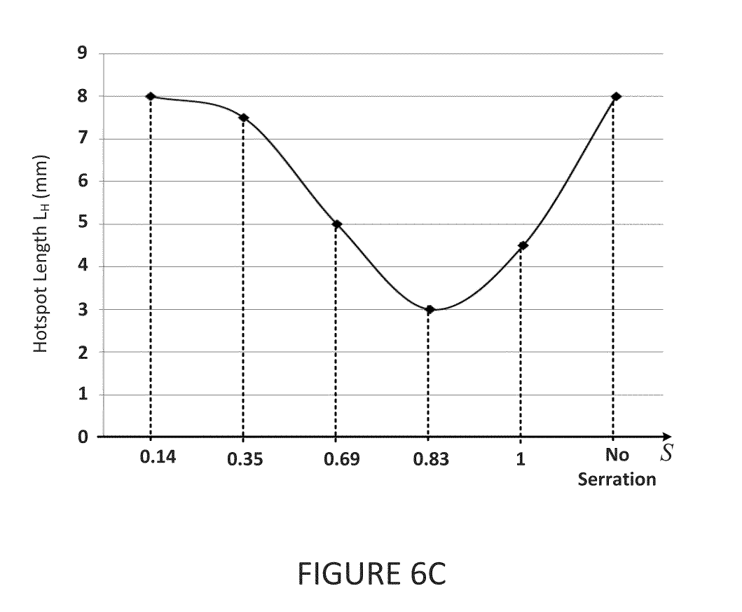

As mentioned above, the light modules are arranged along one side of the light guide 501. In some implementations, the light guide 501 can include a transparent material such as glass or plastic. The light guide 501 receives light from the light sources within the light modules 502, 504, 506, and 508. The light guide 501 is configured such that light enters from one side of the light guide 501 and illuminates substantially evenly all of a front surface 510 of the light guide 501. However, as discussed above, the intensity of light may be unevenly distributed over the front surface of the light guide near the edge where the light sources are situated. This uneven distribution of light intensity can manifest itself in the form of hotspots near the edge of the front surface 510 proximate to the light sources (hotspots are discussed further below in relation to FIGS. 6A-6C). The formation of hotspots can introduce artifacts in the images being displayed to the viewer.

In some implementations, the light guide 501 includes optical structures for reducing or mitigating the formation of hotspots in the light guide 501. For example, FIG. 3A shows four optical structures: a first optical structure 512, a second optical structure 514, a third optical structure 516, and a fourth optical structure 518. The four optical structures 512, 514, 516, and 518 are arranged on a side or surface of the light guide 501 through which light from the light sources is introduced into the light guide 501. Each of the four light modules 502, 504, 506, and 508 is arranged in close proximity with one of the four optical structures 512, 514, 516, and 518. For example, the first light module 502 is arranged proximate to the first optical structure 512, the second light module 504 is arranged proximate to the second optical structure 514, the third light module 506 is arranged proximate to the third optical structure 516, and the fourth light module 508 is arranged proximate to the fourth optical structure 518. The four optical structures 512, 514, 516, and 518 refract the light emitted by the four light modules 502, 504, 506, and 508 before it enters the light guide 501. The shapes, dimensions and arrangements of optical elements included in the four optical structures 512, 514, 516, and 518 can be selected such that the formation of hotspots is reduced.

In some implementations, such as the one shown in FIGS. 3A-3C, each of the four optical structures 512, 514, 516, and 518 include four optical elements. For example the first optical structure 512 includes four first optical elements 522, the second optical structure 514 includes four second optical elements 524, the third optical structure 516 includes four third optical elements 526, and the fourth optical structure 518 includes four fourth optical elements 528. In some implementations, the number of optical elements may be different than the number (four) shown in FIG. 3A. In some implementations, the number of optical elements in an optical structure may be equal to the number of light sources in the associated light module. For example, the first optical structure 512 may include three first optical elements 522, which is equal to the number of light sources (three) in the associated first light module 502. In some other implementations, the number of optical elements in an optical structure may be up to one or two orders of magnitude larger than the number of light sources.

In some other implementations, the number of optical elements in an optical structure may be equal to the number of different colors of light emitted by the associated light module. For example, the first optical structure 512 may include three optical structures 522, one each for one of the three colors: red (R), green (G), and blue (B) emitted by the first light module 502.

In some implementations, the dimensions or orientations of the optical elements in an optical structure may be similar. For example, the sizes of all first optical elements 522 in the first optical structure 512 may be similar. In some implementations, the dimensions and/or orientations of two or more optical elements in an optical structure may be different. For example, the sizes, shapes, and orientations of each of the first optical elements 522 of the first optical structure 512 may be based on the color of the nearest light source in the associated first light module 502. Specifically, one or more of the first optical elements 522 nearest to the red light source of the first light module 502 may have sizes, shapes, and/or orientations that are different from that of another one or more of the first optical elements 522 that are nearest to the blue light source of the first light module 502.

In some implementations, the dimensions and/or optical parameters of the optical elements in one optical structure may differ from that of the optical elements in another optical structure. For example, the dimensions (e.g., size and shape) or orientations of the first optical elements 522 of the first optical structure 512 may differ from the dimensions or orientations of the second optical elements 524 of the second optical structure 514. In such implementations, the difference in the dimensions or orientations may be a function of the color of the light sources in the associated light modules. For example, the first light module 502 associated with the first optical elements 522 includes colors red, green, and blue, which are different from the color white of the light sources in the second light module 504 associated with the second optical elements 524.

FIG. 3B shows a side view of the light guide 501 of the backlight 500. In particular, FIG. 3B shows the side view of the light guide 501 as viewed in the direction indicated by the arrow ‘A’ in FIG. 3A. A side surface, or a light introduction surface, 530 of the light guide 501 is proximate to the four light modules 502, 504, 506, and 508 (shown in FIG. 3A). The four optical structures 512, 514, 516, and 518 are disposed on the side surface 530. Light emitted by the light sources in the four light modules 502, 504, 506, and 508 enters the light guide 501 through the four optical structures 512, 514, 516, and 518 disposed on the side surface 530 before entering the light guide 501.

FIG. 3C shows an isometric view of a portion of the light guide 501. In particular, FIG. 3C shows an isometric view of the third and fourth optical structures 516 and 518 disposed on the side surface 530 of the light guide 501. In some implementations, such as the one shown in FIGS. 3A-3C, each optical element extends from a first edge 532 of the side surface 530 to a second edge 534 of the side surface 530. In some other implementations, one or more optical elements may extend to a distance that is less than the distance between the first edge 532 and the second edge 534. The first and second optical structures 512 and 514 (not shown) can be arranged in a manner similar to the arrangement of the third and fourth optical structures 516 and 518, respectively, shown in FIG. 3C.

The optical structures 512, 514, 516, and 518 have surfaces that project above, or protrude from, the side surface 530 of the light guide 501. In some implementations, the optical structures 512, 514, 516, and 518 can be viewed as serrations on the side surface 530 of the light guide 501. As discussed below, the shapes and dimensions of these serrations, e.g., the optical structures 512, 514, 516, and 518, can be configured to reduce hotspots.

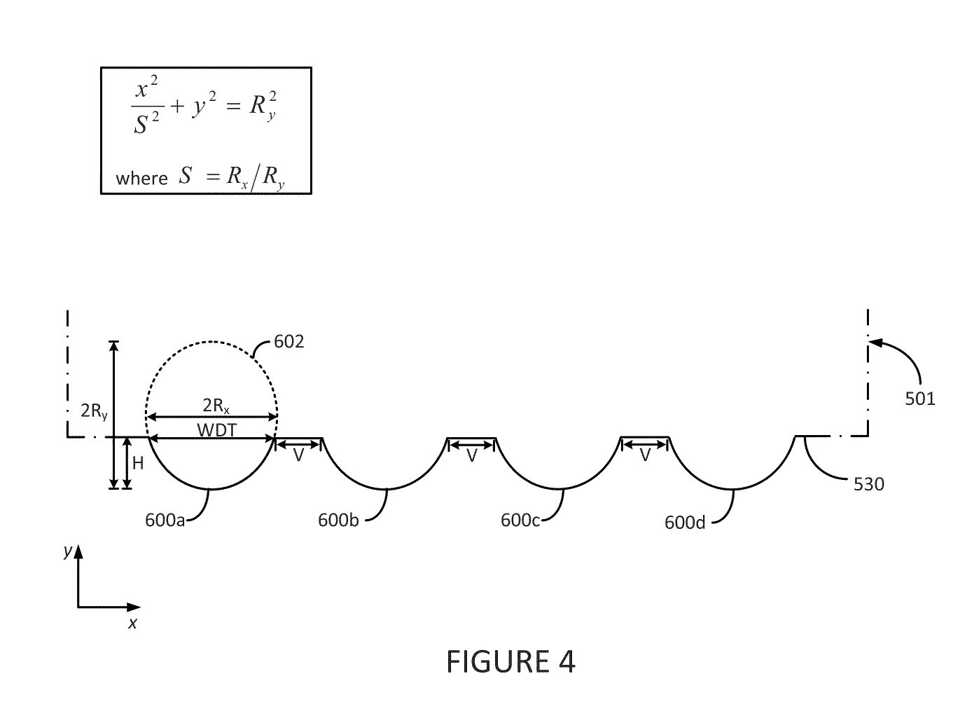

FIG. 4 shows examples of optical elements 600a-600d (collectively referred to as optical elements 600) for reducing hotspots in the backlight 500. In particular, FIG. 4 shows a front view of a portion of the light guide 501 incorporating optical elements 600. While not shown in FIG. 4, the optical elements 600, similar to the optical elements shown in FIG. 3C, can extend for the entire or a portion of the distance between the first edge (not shown) and the second edge (not shown) of the side surface 530. Each of optical elements 600 has a width WDT and a height H above the side surface 530. Furthermore, adjacent optical elements are separated by a gap V.

In some implementations, additional dimensional parameters of the optical elements 600 can be defined by describing each optical element as a section of a solid elliptical cylinder. It is understood that a solid elliptical cylinder includes two substantially parallel elliptical surfaces. It is also understood that a section of the solid elliptical cylinder can be obtained by the intersection of the cylinder and a plane. In FIG. 4, the optical element 600a can be viewed as a section formed by the intersection of a solid elliptical cylinder, the elliptical surface of which is outlined by ellipse 602, and the plane of the side surface 530.

The size of the ellipse 602 along the x-axis and the y-axis is denoted by 2Rₓ and 2R_{y}, respectively. As such, the equation for the ellipse 602 in Cartesian coordinates can be expressed as:

$$\frac{{x}^{2}}{{S}^{2}} + {y}^{2} = {R}_{y}^{2}$$

where S=Rₓ/R_{y}. The variable S, referred to herein as the “stretching factor,” describes the shape of the ellipse 602, and, in turn, the shape of the optical elements 600. By varying the various parameters (such as, WDT, H, V, and S) associated with the optical elements 600, various shapes and sizes of the optical elements 600 can be obtained.

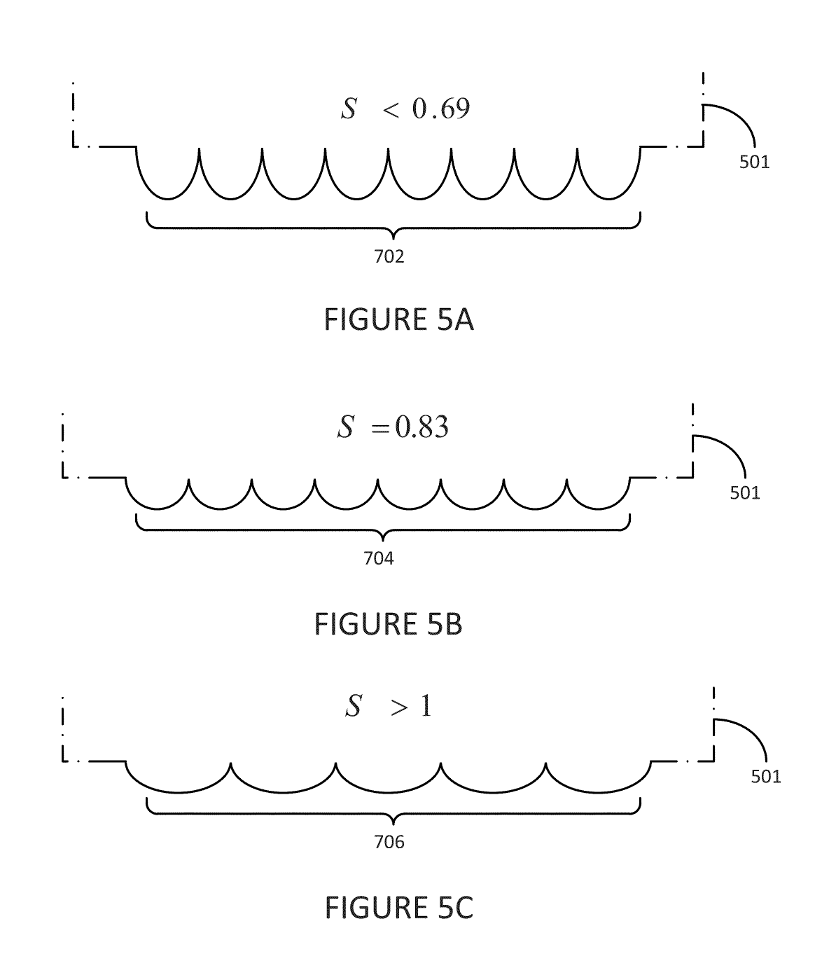

FIGS. 5A-5C show various examples of optical elements having various stretching factor values. In particular, FIG. 5A shows a front view of a portion of the light guide 501 incorporating optical elements 702 having a stretching factor S<0.69; FIG. 5B shows a front view of a portion of the light guide 501 incorporating optical elements 704 having a stretching factor S=0.83; and FIG. 5C shows a front view of a portion of the light guide 501 incorporating optical elements 706 having a stretching factor S>1. In some implementations, such as the ones shown in FIGS. 5A-5C, the gap V between the optical elements can be equal to zero. In some other implementations, the optical elements can be configured to have a non-zero gap V.

FIGS. 6A-6C show simulation results obtained for a light guide, such as the light guide 500 shown in FIG. 5A. In particular, FIG. 6A shows simulation results of light intensities in the light guide with and without serrations. FIG. 6A also shows that incorporating serrations in the light guide can result in the reduction in hotspots. Specifically, FIG. 6A shows a first surface light intensity plot 802 of light intensities on a front surface of a light guide without serrations, and a second surface light intensity plot 804 of light intensities on the front surface of the light guide with serrations. In particular, the second plot 804 assumes that the light guide includes serrations similar to the ones shown in FIG. 5B, in which the stretching factor S of the optical elements 704 is equal to 0.83, and the gap V is equal to zero. Furthermore, the plot 804 also assumes that the width WDT and the height H of the optical elements are about 59.8 μm and about 35 μm, respectively (WDT and H are shown in FIG. 4). Additionally, both the plots 802 and 804 assume that the emission width E_{w} of the light source is about 1.4 mm and the pitch is equal to about 10 mm (E_{w} and pitch are shown in FIG. 3A).

The bottom edges of the first plot 802 and the second plot 804 correspond to an edge of the top surface of the light guide along which light sources are situated. For example, the bottom edge of the first plot 802 and the second plot 804 can correspond to the bottom edge of the top surface 510 of the light guide 501 shown in FIG. 3A along which the light modules 502, 504, 506, and 508 are situated. Furthermore, the first plot 802 and the second plot 804 are plotted with light sources of the same color (e.g., green) illuminating the light guide. Arrows 806a, 806b, and 806c indicate positions of green light sources along the bottom edge of the light guide. For example, arrows 806a and 806b may correspond to the positions of green light sources in the first light module 502 and the third light module 506, respectively, along the bottom edge of the top surface 510 shown in FIG. 3A. It is understood that while the simulations assume that the light sources are green, similar results can be obtained for light sources of other colors (e.g., red, blue, white, etc.). Each of the first plot 802 and the second plot 804 are overlaid with lines L₁ and L₂, both of which are parallel to the y-axis, to aid in measuring the intensity of light on the surface of the light guide. In particular, line L₁ begins at a point that is equidistant from the positions of the two light sources, while line L₂ begins at a point that is coincident with the position of a light source.

As shown in the first and second plots 802 and 804, the intensity of light near the bottom edge of the light guide is unevenly distributed. Intensity of light near the positions indicated by arrows 806a, 806b, and 806c is higher than the intensity of light between these positions. However, this difference in the light intensity diminishes with increasing distance from the bottom edge. The ratio R_{IL} measures the ratio of the intensity of light at a first distance from the edge of the light guide along the line L₁ to the intensity of light the same distance from the edge of the light guide along the line L₂. As shown in FIG. 6A, the value of R_{IL} increases as the distance from the edge of the light guide increases, until the ratio converges at around 1.0.

In some implementations, the size or length (L_{H}) of the hotspots produced by a backlight can be determined by determining the distance from the edge of the light guide for which the ratio R_{IL} is substantially equal to 1.0, or for which the ratio R_{IL} converges to within 10% of 1.0 (i.e., 1.1≧R_{IL}≧0.9). In the plot 802, the line 808 intersects line L₁ and L₂ at points for which the ratio R_{IL} of a backlight without serrations converges to within 10% of 1.0. Similarly, in the plot 804, the line 810 intersects lines L₁ and L₂ at points for which the ratio R_{IL} of a backlight with serrations converges to within 10% of 1.0. The respective distances of the lines 808 and 810 along the y-axis correspond to the lengths of the hotspots in the respective backlights. For example, the length of the hotspots for a light guide having no serrations or optical elements (such as the ones discussed above in relation to FIGS. 3A-5C) is indicated by point L_{H no serration} on the y-axis. Similarly, the length of the hotspots for a light guide having serrations similar to the one discussed in relation to FIG. 5B, is indicated by point L_{H with serration} on the y-axis. As evident from FIG. 6A, L_{H no serration} is further along the y-axis than L_{H with serration}. In other words, by incorporating serrations into the light guide, the length of the hotspots can be reduced.

FIG. 6B shows simulation results for values of R_{IL} corresponding to various stretching factors. In particular, FIG. 6B shows plots for R_{IL} corresponding to stretching factors of 1.04, 0.83, 0.69, 0.35, and 0.14. FIG. 6B also includes a graph for R_{IL} corresponding to a light guide without any serrations or optical elements. All the R_{IL} graphs are plotted against the y axis shown in FIG. 6A, which represents the distance from the edge of the light guide along which the light sources are located. The value of R_{IL} in all of the plots increases as the distance from the edge of the light guide increases up to a point, and then converges towards a value of 1.0. Each graph for R_{IL} shown in FIG. 6B also assumes the following: the width WDT is equal to S times 72 μm and the height H is equal to 35 μm. For example, for a stretching factor S equal to 1.04, the width WDT is equal to 74.88; for a stretching factor S equal to 0.69, the width is equal to 49.68; and so on. Furthermore, Rₓ and R_{y} are selected to achieve the desired stretching factor S. For example, for a stretching factor S equal to 1.0, both R_{X} and R_{y} are selected to be equal to 36 μm. Furthermore, the emission width E_{w} and the pitch of the light source are 1.4 mm and 10 mm, respectively. Similar plots would result from similar optical elements having different dimensions.

FIG. 6C shows a graph of hotspot lengths corresponding to various stretching factors. The graph in FIG. 6C is derived from the R_{IL} plots shown in FIG. 6B. As mentioned above, the size or length L_{H} of the hotspots can be determined by determining the distance from the edge of the light guide for which R_{IL} has converged to a value substantially equal to 1.0, or for which R_{IL} has converged to within 10% of 1.0 (i.e., 1.1≧R_{IL}≧0.9). Thus, by determining the values of Y in FIG. 6A for which the ratio R_{IL} corresponding to a particular stretching factor converges, without relapse, to within the range of 0.9 to 1.1, the length L_{H} of the hotspots for that particular stretching factor can be determined. With respect to the stretching factors evaluated, FIG. 6C shows that the length L_{H} of the hotspots is smallest for a stretching factor of 0.83.

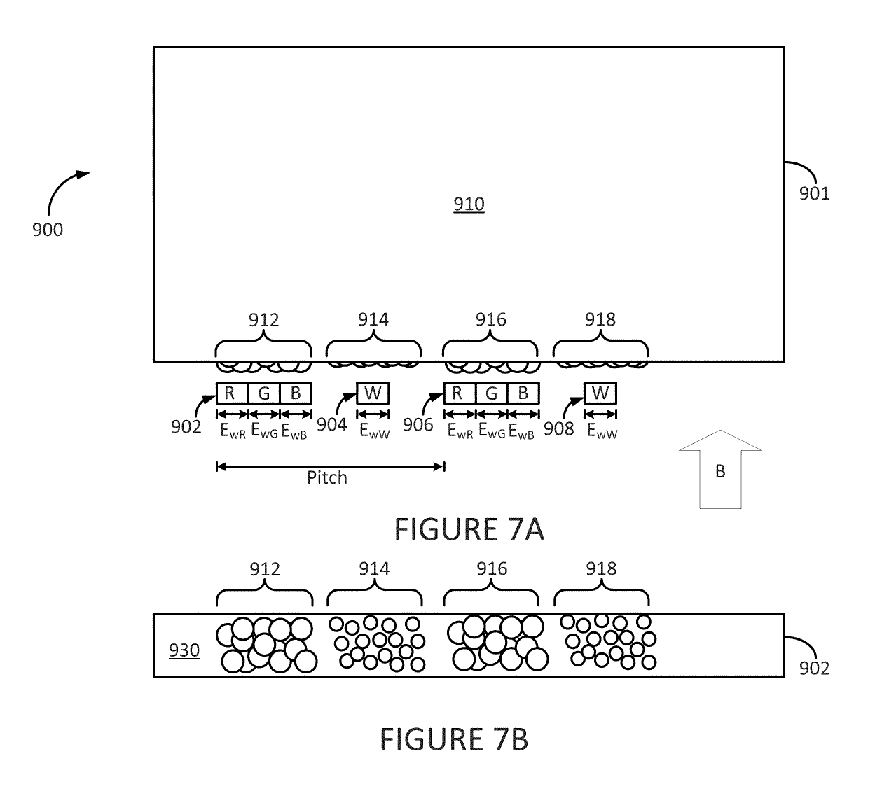

FIGS. 7A and 7B show various views of another example multi-color illuminated backlight 900. In particular, FIG. 7A shows a front view of the backlight 900 and FIG. 7B shows a side view of a light guide 901 of the backlight 900 as viewed in the direction of the arrow B. The backlight 900 also includes one or more light modules for providing light of various colors. For example, the backlight 900 includes a first light module 904, a second light module 906, a third light module 908 and a fourth light module 910. Similar to the light modules 504, 506, 508, and 510 discussed above in relation to FIG. 3A, the first light module 904 and the third light module 908 each include light sources of red (R), green (G), and blue (B) colors; and the second light module 906 and the fourth light module 910 each include one or more white (W) color light sources.

Similar to the light guide 501 shown in FIG. 3A, the light guide 901 also includes optical structures configured to reduce hotspots in the light guide 901. For example, the light guide 901 includes four optical structures 912, 914, 916, and 918, each positioned adjacent to one of the four light modules 902, 904, 906, and 908 on a side surface 930. But, in contrast with the light guide 501 shown in FIG. 3A, which included serrations as optical elements, the optical structures 912, 914, 916, and 918 can include non-serrated optical elements. For example, the optical structures 912, 914, 916, and 918 includes raised dimples. In some implementations, the dimples are randomly arranged within the optical structure. In some other implementations, the dimples are arranged in rows and columns within the optical structure. In some implementations the dimples in different optical structures 912, 914, 916, and 918 may differ in number, size, height, depth, density, and/or arrangement. In some implementations, the width of the dimples in one or more of the optical structures 912, 914, 916, and 918 can be between about 10 μm and 100 μm. In some implementations, a ratio of a width of the dimples measured in the plane of the side surface 930 over a height of the dimples measured normal to the side surface 930 can be between about 1.5 and 1.9. In some implementations, the dimples can be closely packed, while in some other implementations, adjacent dimples may have a small gap or overlap. In some other implementations, optical elements having shapes such as, cones, pyramids, prisms, etc. can also be utilized.

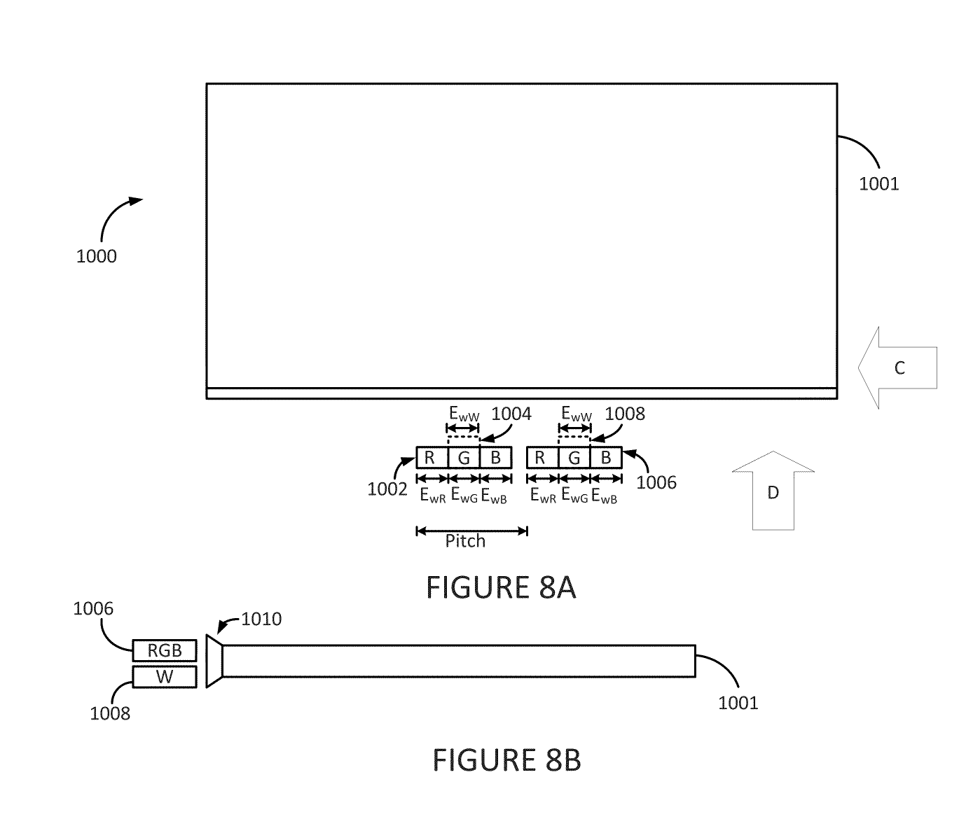

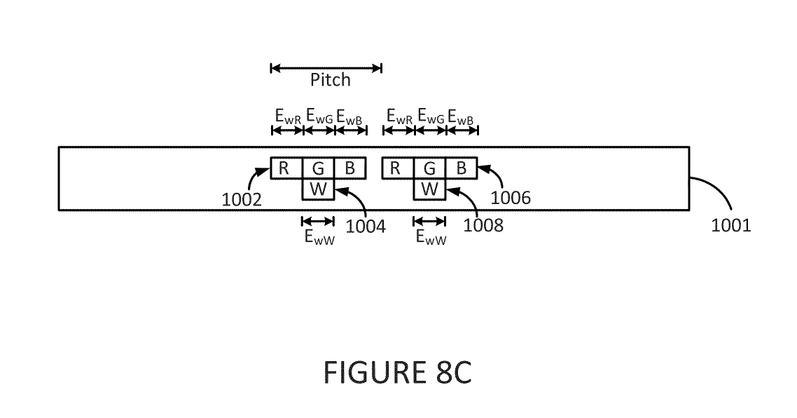

FIGS. 8A-8C show various views of yet another example multi-color illuminated backlight 1000. In particular, FIG. 8A shows a front view of the backlight 1000 and FIGS. 8B and 8C show side views of the backlight 1000 as viewed in the direction of the arrows in FIG. 8A labeled C and D, respectively. Similar to the backlight 500 discussed above in relation to FIG. 3A, the backlight 1000 shown in FIG. 8A also includes a first light module 1002 and a third light module 1006, each having light sources of red (R), green (G), and blue (B) colors; and a second light module 1004 and a fourth light module 1008, each having white colored light sources. However, in contrast with the backlight 500, in which light modules (e.g., light module 502) having R, G, and B light sources are positioned adjacent to light modules (e.g., light module 506) having white light sources along the length of the edge of the light guide 501, light modules (e.g., light module 1002) having R, G, and B light sources and light modules (e.g., light module 1004) having white light sources in the backlight 1000 are positioned one above the other at common positions along the length of the light guide 1001, as shown in FIGS. 8B and 8C. This arrangement allows for reduced spacing (i.e., pitch) between adjacent light modules having similar color light sources. For example, the pitch corresponding to the first and third light modules 1002 and 1006 of the backlight 1000 is smaller than the pitch corresponding to the first and third light modules 502 and 506 of the backlight 500 shown in FIG. 3A. Generally, an increase in the ratio of the emission width, E_{w}, for light sources of a color over their pitch results in the decrease in the size of the hotspots generated for that color. Thus, reduction in the size of the hotspots can be achieved by reducing the pitch.

Furthermore, the emission width E_{wW} of the white color light source can be increased without increasing the pitch of the R, G, B, or W light sources. In some implementations, the number of white color light sources can be increased without affecting the pitches of the R, G, or B light sources. For example, more than one white color light source can be incorporated in the second and fourth light modules 1004 and 1008. However, as the second and fourth light modules 1004 and 1008 are not interspaced with the first and second light modules 1002 and 1006, the increase in the number of white color light sources does not affect the pitch of the light sources in the first and second light modules 1002 and 1006. Similarly, an increase in the number of light modules does not affect the pitch of the light sources. For example, having white light modules in addition to the second and fourth light modules 1004 and 1008 will not affect the pitch of the light sources in the first and third light modules 1002 and 1006.

In some implementations, the arrangement of the light modules shown in FIGS. 8A-8C, however, may incorporate a thicker light guide 1001. In some implementations, the light guide 1001 may include a tapered end 1010 adjacent to the light modules that directs the light emitted from the light modules into a standard thickness light guide 1001. In this manner, only the portion of the light guide 1001 that is adjacent to the light modules needs to be thicker.

In some implementations, the light guide 1001 may also include optical structures for reducing the size of hotspots. For example, the light guide 1001 may include one or more optical structures discussed above in relation to FIGS. 3A-5C, and 7A-7B.

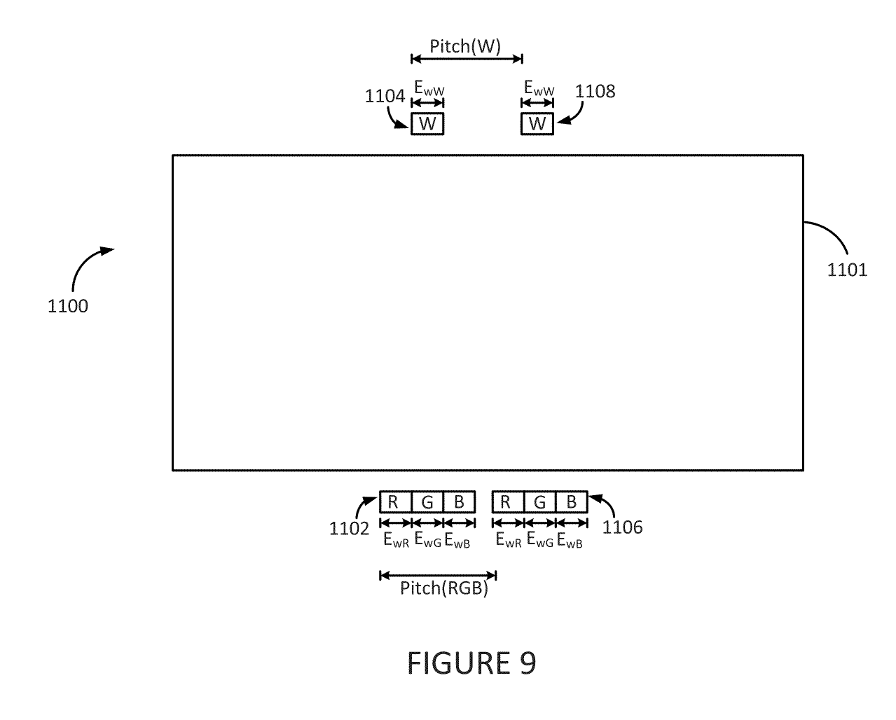

FIG. 9 shows a top view of another example multi-color illuminated backlight 1100. The backlight 1100 includes a light guide 1101 and four light modules: a first light module 1102 and a third light module 1106, each having light sources of red (R), green (G), and blue (B) colors; and a second light module 1104 and a fourth light module 1108, each having white (W) colored light sources. In contrast to the backlights 500, 900, and 1000 shown in FIGS. 3A, 7A, and 8A, in which all the light modules were arranged along the same side of their respective light guides, the light modules in the backlight 1100 shown in FIG. 9 are arranged along opposite sides of the light guide 1101. For example, the first and the third light modules 1102 and 1106 are arranged on one side of the light guide 1101, while the second and the fourth light modules 1104 and 1108 are arranged on the opposite side of the light guide 1101. The first and third light modules 1102 and 1106 can be situated proximate to a first light introduction surface on one side of the light guide 1101, while the second and fourth light modules 1104 and 1108 can be situated proximate to a second light introduction surface on the opposite side of the light guide 1101. The first and second light introduction surfaces can be similar to the side surface 530 of light guide 501 shown in FIG. 3C but located on opposite sides of the light guide 1101. This arrangement of the light modules on opposite sides of the light guide 1101 allows for a reduction in the pitch, and therefore an increase in the ratio of the emission width, E_{w}, over the pitch associated with the light sources of each color. As mentioned above, reducing this ratio results in a reduction in the size of hotspots. Furthermore, the emission width E_{W} of the white color light source can be increased without increasing the pitch of the R, G, B, or W light sources. Similarly, adding additional light modules, such as adding an additional white light module, does not affect the pitch of the R, G, B, or W light sources.

In some implementations, the light guide 1101 may also include optical structures for reducing the size of hotspots. For example, the light guide 1101 may include one or more optical structures discussed above in relation to FIGS. 3A-5C. One or more of these optical structures can be situated on the first and second light introduction surfaces of the light guide 1101. The optical structures can be proximate to the first, second, third and fourth light modules 1102, 1104, 1106, and 1108 such that light emitted by these light modules passes through the optical structures before entering the light guide 1101.

In some implementations, the light modules arranged on the opposite sides of the light guide may be of the same type. For example, both opposite sides of the light guide 1101 can include light modules having light sources of red, green, and blue colors. Similarly, both opposite sides of the light guide can include light modules having white colored light sources. In some other implementations, light modules having one or more light sources can be arranged along more than two sides of the light guide.

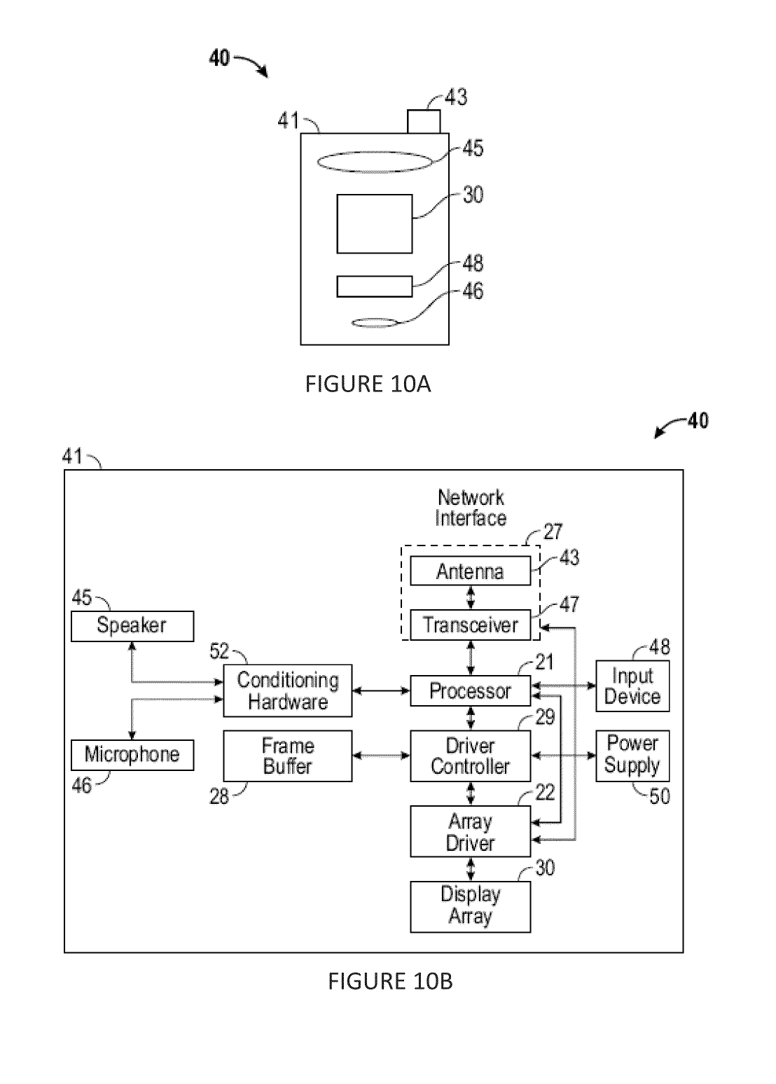

FIGS. 10A and 10B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 10B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a substantially planar light guide having a first light introduction surface and a second light introduction surface;
a first light module having light sources of a first set of colors positioned proximate to the first light introduction surface; and
a second light module having light sources of a second set of colors, the second set being different from the first set, positioned proximate to the second light introduction surface.

2. The apparatus of claim 1, wherein the first set of colors includes red, green, and blue, and the second set of colors includes white.

3. The apparatus of claim 1, wherein the light guide comprises:
a first optical structure disposed on the first light introduction surface proximate to the first light module such that light emitted from the first light module passes through the first optical structure before entering the light guide; and
a second optical structure disposed on the second light introduction surface proximate to the second light module such that light emitted from the second light module passes through the second optical structure before entering the light guide.

4. The apparatus of claim 3, wherein the first optical structure is configured differently from the second optical structure.

5. The apparatus of claim 3, wherein at least one of the first optical structure and the second optical structure includes serrations.

6. The apparatus of claim 5, wherein the serrations include protrusions having elliptical cross-sections, the elliptical cross-sections having a first axis and a second axis orthogonal to the first axis, wherein a ratio of the first axis over the second axis is equal to about 0.83.

7. The apparatus of claim 3, wherein at least one of the first optical structure and the second optical structure includes raised dimples.

8. The apparatus of claim 1, further comprising a third light module having light sources of the first set of colors positioned proximate to the first light introduction surface and adjacent to the first light module wherein a distance between light sources of the same color in the first light module and the second light module is at least four times an emission width of the light sources.

9. The apparatus of claim 1, further comprising:
a display;
a processor that is configured to communicate with the display, the processor being configured to process image data; and
a memory device that is configured to communicate with the processor.

10. The apparatus of claim 9, the display further including:
a driver circuit configured to send at least one signal to the display; and
a controller configured to send at least a portion of the image data to the driver circuit.

11. The apparatus of claim 9, the display further including:
an image source module configured to send the image data to the processor, wherein the image source module comprises at least one of a receiver, transceiver, and transmitter.

12. The apparatus of claim 9, the display further including:
an input device configured to receive input data and to communicate the input data to the processor.

13. An apparatus, comprising:
a substantially planar light guide having a light introduction surface having a first axis along the length or the width of the light guide and a second axis along the thickness of the light guide;
a first set of light modules positioned proximate to the light introduction surface, wherein the group of light modules are aligned along the first axis; and
a second set of light modules positioned proximate to the light introduction surface, each positioned at about a same distance along the first axis and adjacent a corresponding light module in the first set of light modules along the second axis.

14. The apparatus of claim 13, wherein the first set of light modules includes a first light module having a red light source, a green light source and a blue light source and a second light module having a white light source.

15. The apparatus of claim 14, wherein the red light source, the green light source, and the blue light source of the first light module are aligned along the longer dimension of the light introduction surface.

16. The apparatus of claim 13, further comprising a third set of light modules positioned adjacent to the first set of light modules along the first axis, wherein a distance between a light source of a color in the first set of light modules and a light source of the same color in the third set of light modules is at least four times an emission width of the light source of the color.

17. The apparatus of claim 13, further comprising a first optical structure disposed on the light introduction surface proximate to the first set of light modules such that light emitted from the first set of light modules passes through the first optical structure before entering the light guide.

18. The apparatus of claim 17, wherein the first optical structure includes serrations extending along the shorter dimension of the light introduction surface.

19. The apparatus of claim 17, wherein the first optical structure includes dimples.

20. An apparatus comprising:
means for displaying images;
means for guiding light to illuminate the means for displaying images;
means for generating the light to input to the means for guiding light, the means for generating the light including first means for generating light of a first set of colors and second means for generating light of a second set of colors, wherein the first set of colors and the second set of colors are different; and
means for reducing hotspots formed by the light in the means for guiding light.

21. The apparatus of claim 20, wherein the means for reducing hotspots include a first set of serrations to refract the light of the first set of colors and a second set of serrations to refract the light of the second set of colors, wherein the first set of serrations and the second set of serrations are of different dimensions.

22. The apparatus of claim 20, wherein the first set of colors includes red, green, and blue, and the second set of colors includes white.
